(19) United States
(12) Patent Application Publication
(10) Pub. No.: US 2026/0111957 A1
(43) Pub. Date: Apr. 23, 2026

(54) PLATFORM AND METHODS FOR LINKING AND MANAGING DIGITAL ASSETS FOR INTEGRATION INTO TRADITIONAL FINANCIAL ASSET MANAGEMENT SYSTEMS

(71) Applicant: Ledgerlink Corporation, Round Rock, TX (US)

(72) Inventors: Nitin Gaur, Round Rock, TX (US); Paulo Jorge Jacinto Rodrigues, Marfa (PT); Rafael Alberto Margues Torres, Barcelos (PT); Ruben José Ramos de Macedo, Setúbal (PT)

(21) Appl. No.: 18/924,979

(22) Filed: Oct. 23, 2024

(51) Int. Cl. G06Q 40/04; G06Q 20/36; G06Q 40/06

(52) U.S. Cl. CPC G06Q 40/04; G06Q 20/36; G06Q 40/06

(57) ABSTRACT

A platform that enterprises can use to integrate traditional asset management with newer distributed transaction ledgers (DTLs), i.e., blockchains is described. The platform's infrastructure couples traditional enterprise ledger systems with digital asset transaction systems thereby equipping a traditional enterprise with the ability to integrate digital assets into their traditional platforms giving them the ability to evaluate, buy, hold, monitor, and sell their assets, both digital and traditional using state of the art DTLs and asset tokenization.

The system and methods as described provide a platform that enterprises can use to integrate traditional asset management with newer distributed transaction ledgers (DTLs), i.e., blockchains. The system and methods as described include an infrastructure to couple traditional enterprise ledger systems with digital asset transaction systems thereby equipping a traditional enterprise with the ability to integrate digital assets into their traditional platforms giving them the ability to evaluate, buy, hold, monitor, and sell their assets, both digital and traditional, using state of the art DTLs and asset tokenization. The system and methods as described fill the gap that exists between traditional ledger systems and digital assets providing a universal platform that can fluidly shift assets between the traditional ledger environment and the digital environment making it unnecessary for enterprises to create or adopt complex systems for assimilating digital assets into their existing custody structures. The system and methods provide the infrastructure needed to communicate between the traditional systems and DTLs, allowing them to run in parallel without the need for duplication or reconciliation, thereby preserving transaction finality in each system. The system and methods further facilitate the use and adoption of DTLs by traditional custody providers allowing them to take advantage of new opportunities without compromising on security or compliance.

### BACKGROUND

The financial world has historically been dominated by centralized institutions that serve as the backbone of economic activity. Banks, investment firms, and insurance companies have played a crucial role in managing and distributing wealth. In recent years, the financial landscape has witnessed a seismic shift with the emergence of digital assets and blockchain technology. Digital assets, including cryptocurrencies, tokenized assets, and stablecoins, offer a decentralize alternative to traditional finance. They promise to democratize access to financial services, reduce transaction costs, and enable new forms of economic participation. And, while these innovations have the potential to revolutionize finance by enhancing transparency, efficiency, and accessibility, traditional financial enterprises, like banks, have been slow to embrace digital assets.

Integrating digital assets into existing traditional financial systems has proven challenging. Financial institutions, corporate treasuries, and private markets face numerous obstacles, including technology debt, operational inefficiencies, and complex regulatory requirements.

The integration of digital assets into traditional systems continues to meet resistance due to concerns over security, compliance, and technological complexity. Enterprise integration, especially using an adjacent system, for many enterprises is a non-starter based on cost and complexity, without consideration to the fact that the enterprise would have to adopt and maintain, two ledger systems.

All of these issues continue to impede enterprise adoption of DTLs.

The ledger integration platform as described herein addresses the shortcomings associated with prior systems and provides a cost effective and comprehensive system that traditional financial institutions can use to integrate digital assets into their existing architectures without having to worry about security, regulatory compliance, or obsolescence based on the fast pace of innovation in the digital markets. The platform as described allows traditional enterprises to take full advantage of what DTLs can offer in terms of speed, convenience and security.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In an aspect, the invention is directed a system and method for incorporating digital assets into a traditional ledger system including receiving from a traditional ledger user via a processor, a request for purchase, sale or custody of a digital asset within a distributed transaction ledger (DTL); obtaining, via the processor, information on the digital asset from the DTL; recording, via the processor, custody of the digital asset including any required key(s); determining, via the processor, the value of the digital asset; determining, via the processor, the asset class of the digital asset and the proper messaging standard associated with the user's traditional ledger; applying, via the processor, the proper messaging standard and asset class to generate a digital asset recordation notice; and sending to the user of the traditional ledger, the digital asset recordation notice instructing them to record the digital asset in their traditional ledger.

A method and system for integrating digital asset transactions with an enterprise governance system including a processor; and a memory for storing computer executable instructions, the processor configured to execute the instructions to provide to an enterprise user, via a processor, an interface for requesting a transaction relating to a digital asset within a distributed transaction ledger (DTL); obtain, via the processor, information on the digital asset from the DTL and comparing the information to a general ledger of assets belonging to the traditional ledger user and updating the general ledger, if needed; obtain, via the processor, any required keys for executing the required transaction; generate, via the processor, a smart contract for executing the transaction on the DTL; sign, via the processor, the smart contract and recording the smart contract on the DTL; update, via the processor, any key(s) associated with the digital asset; update, via the processor, the status of the digital asset in the general ledger of assets belonging to the traditional ledger user; and provide, via the interface, confirmation of the execution of the transaction.

A system and method for providing combinatorial analysis of assets recorded in both a distributed ledger technology (DTL) and a traditional ledger system including obtaining, via a processor, information on one or more digital assets from a DTL; recording, via the processor, custody of the one or more digital assets including any required key(s); determining, via the processor, the value of the one or more digital assets; recording, via the processor, the one or more digital assets and their values in a general ledger; obtaining, via a processor, information on one or more traditional assets contained within a traditional ledger; recording, via the processor, the one or more traditional assets contained in the traditional ledger; and performing, via the processor, combinatorial analysis of the aggregated assets contained in the general ledger.

A system and method for monitoring and confirming the existence of digital assets including a) obtaining, via a processor, information regarding an asset from one or more digital asset ledgers or traditional ledgers; b) from the information obtained, generating, via the processor, a global ledger with the state of the asset as found in the digital asset ledgers or traditional ledgers; c) generating, via the processor, a periodic check on the status of the asset in the one or more digital asset ledgers or traditional ledgers; d) comparing in real-time, via the processor, the status of the assets from the periodic check with the global ledger to identify discrepancies; and e) when discrepancies are found, initiating, via the processor, corrective actions.

A system and method for integrating a tokenized digital asset into a traditional ledger including receiving, via the processor, asset data regarding one or more tokenized digital assets in a digital asset transaction system; securing, via the processor, custody of the tokenized digital asset; receiving, via the processor, valuation data for the tokenized digital asset from one or more market data providers; recording, via the processor, the custody and the value of the tokenized digital asset digital asset in a general ledger; and generating, via the processor, a message in a format compatible with the traditional ledger for recording the tokenized digital asset and its value into their system.

### DESCRIPTION

The features and components of the following figures are illustrated to emphasize the general principles of the present disclosure. Corresponding features and components throughout the figures can be designated by matching reference characters for the sake of consistency and clarity.

### BRIEF DESCRIPTION OF THE DRAWINGS

FIG. 1 is a block diagram of a ledger integration platform according to embodiments of the present disclosure.

FIG. 2 is a block diagram of one embodiment of the Asset Transaction Rail illustrated in FIG. 1.

FIGS. 3A and 3B are block diagrams of embodiments of the Linking Infrastructure illustrated in FIG. 1.

FIG. 4 is a block diagram of one embodiment of the Liquidity Management Engine illustrated in FIG. 1.

FIG. 5 is a block diagram of one embodiment of the Security and Compliance framework illustrated in FIG. 1.

FIG. 6 is a is a block diagram of a computer-based Ledger Integration System according to embodiments of the present disclosure.

FIG. 7 depicts an example computing environment in which the Ledger Integration System may operate according to embodiments of the present disclosure.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

The following description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

In the following discussion and in the claims, the terms “including,” “comprising,” and “is” are used in an open-ended fashion, and thus should be interpreted to mean “including, but not limited to.”

As used throughout, the singular forms “a,” “an” and “the” include plural referents unless the context clearly dictates otherwise. Thus, for example, reference to a quantity of one of a particular element can comprise two or more such elements unless the context indicates otherwise.

Ranges can be expressed herein as from “about” one particular value, and/or to “about” another particular value. When such a range is expressed, another aspect comprises from the one particular value and/or to the other particular value. Similarly, when values are expressed as approximations, by use of the antecedent “about” or substantially,” it will be understood that the particular value forms another aspect. It will be further understood that the endpoints of each of the ranges are significant both in relation to the other endpoint, and independently of the other endpoint.

For purposes of the present disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list.

To simplify the description of various elements disclosed herein, the conventions of “top,” “bottom,” “side,” “upper,” “lower,” “horizontal,” and/or “vertical” may be referenced. Unless stated otherwise, “top” describes that side of the system or component that is facing upward and “bottom” is that side of the system or component that is opposite or distal the top of the system or component and is facing downward. Unless stated otherwise, “side” describes that an end or direction of the system or component facing in horizontal direction. “Horizontal” or “horizontal orientation” describes that which is in a plane aligned with the horizon. “Vertical” or “vertical orientation” describes that which is in a plane that is angled at 90 degrees to the horizontal.

The system and methods as described provide a platform that enterprises can use to integrate traditional asset management with newer distributed transaction ledgers (DTLs), i.e., blockchains. Assets are held by regulated/licensed custodians, either in the real world or in the digital world. The ledger integration platform as describes deals with asset representation in both traditional ledgers and digital asset transaction systems. The ledger integration platform coordinates with databases and blockchains seamlessly, monitoring transactions within the digital asset transaction systems and providing an efficient messaging system for Traditional Custody Providers to update their records/ledger, as a result of transactions triggered by the participants on our platform.

The system and methods as described include an infrastructure to couple traditional enterprise ledger systems with digital asset transaction systems thereby equipping a traditional enterprise with the ability to evaluate, buy, hold, monitor, and transfer their assets, both digital and traditional using state of the art DTLs and asset tokenization. The linking infrastructure allows the user to access different modules that can interact with both DTLs and their traditional ledger system. The modules allow the user to link to enterprise wallets to buy, sell, and manage digital assets; verify the existence and value of digital assets, link and hold digital assets for transactions, confirm appropriate liquidity before engaging in digital transactions; perform appropriate routing and smart contract generation for digital transactions; and generate smart messages to inform transactions under appropriate protocols on both the traditional ledger side and the digital ledger side, all while adapting for necessary compliance and security protocols.

The system and methods as described fill the gap that exists between traditional ledger systems and digital assets providing a universal platform that can fluidly shift assets between the traditional ledger environment and the digital environment making it unnecessary for enterprises to create or adopt complex systems for assimilating digital assets into their existing custody structures. The system and methods further facilitate the use and adoption of DTLs by traditional custody providers allowing them to take advantage of new opportunities without compromising on security or compliance.

### Definitions

As used herein “traditional ledger” refers to any enterprise transaction system, for example, cash management or treasury management that is used to record or store asset transactions.

As used herein “Traditional Custody Providers” refer to enterprises, such as financial institutions, e.g., banks, investment firms, insurance companies, credit unions, savings and loan associations, pension funds, brokerage firms, asset management firms, and the like that rely upon traditional ledger systems to carry out and record transactions.

As used herein “enterprise governance system” refers to the protocols associated with a particular traditional ledger. Each enterprise has its own rules for how they handle and record transactions within their particular financial system. The rules and protocols have many similarities as they are often controlled by regulation, but each enterprise has its own system for handling assets and transactions.

As used herein “traditional asset administrator” or “traditional ledger administrator” or “enterprise user” are used interchangeably and all refer, in context, to individuals who may use the platform as described including individuals or system that govern and carry out the recording of transactions within a traditional ledger.

As used herein “digital asset administration” refers to use of the systems of DTLs and smart contracts that govern the recording of transactions surrounding a digital asset transaction system.

As used herein “digital asset transaction systems” refers to DTLs, public and private blockchains, Directed Acyclic Graph (DAG), federated or consortium ledgers, permissioned Ledgers, permissionless Ledgers, Hashgraph, Tangle, any smart contract platform or any other art recognized system for transacting digital assets.

As used herein “digital asset” refers to any digital material that can be stored and transmitted electronically through a computer or other digital device and which includes associated ownership or use rights. Digital assets include anything which is tokenizable. Digital assets as defined herein include, without limitation, digital currency, for example, bank or brokerage accounts including any after developed digital currencies issued by governments or institutions tasked with the issuance of global currency; stablecoins; cryptocurrency, including BITCOIN®, SOLANA®, CARDANO®, POLKADOT®, BITCOIN® Cash, LITECOIN®, DOGECOIN®, ETHEREUM®, RIPPLE®, BINANCE® COIN, TETHER®, POLYGON®, etc. ; tokens, including initial coin offerings, security tokens; NFTs, like, art, music, photography, videography, video game contents, digital trading cards/coins, videographic history, including sports clips, memes, social media, including the first tweet, domain names, virtual fashion, virtual real estate, entitlements, including tickets or subscriptions, and even digital pets; social media and on-line accounts, including, for example, TikTok, Facebook, Instagram, Apple Music; digital files, including images, audio files, video files, and documents.

As used herein “digital asset ledgers” refers to the records associated with transactions surrounding digital assets in a digital asset transaction systems.

As used herein “Distributed Ledger Technology,” (DLT) and “blockchain” are used interchangeably to refer to transactions that are stored and recorded across multiple networks and locations.

As used herein “Liquidity Management Engine” refers to an AI-powered tool for efficient asset management and transaction processing. It includes features like Predictive Analytics, Knowledge Graphs, Intelligent Asset Management and Liquidity Reporting for optimized liquidity management. Traditional ledger-based systems typically have transaction times that are extended, and financial institutions work within these transactions times to be sure they maintain an appropriate level of liquidity. With the inclusion of DTL transactions in traditional ledgers, which transactions are immediate, the Liquidity Management Engine, uses a number of different platforms to assure appropriate levels of liquidity are preserved in the traditional institution when DTL transactions are involved.

As used herein “Ledger Integration Platform” refers to refers to the system comprising an Asset Transaction Rail, a Linking Infrastructure, and a Liquidity Management Engine, which in combination facilitate the integration of digital assets found in the Public or private blockchains into traditional financial systems used by Traditional Custody Partners.

As used herein, “Linking Infrastructure” refers to the portion of the platform that acts as a back-office plugin that facilitates seamless integration between DLTs and existing financial systems. It generally includes an enterprise wallet, a smart data hub, and a standardized API gateway, but it may also include other modules.

As used herein “link gate” refers to a secure storage solution for digital assets including tokenized assets. It supports multi-signature authentication and cold storage, providing a high level of security for an enterprise's digital assets. As a means for understanding the link gate, it is a platform module that replaces the need for the enterprise to have an associated DTL to hold their digital assets for them. The link gate provides all the enterprise with all of the transaction capability to an “enterprise wallet.” The link gate allows asset storage, key storage, security integration, regulatory compliance integration, digital signature capability and smart contract integration among other things.

As used herein a “digital wallet” refers to commercial software platforms that stores cryptocurrency. There are a variety of different commercial versions of the digital wallet, and each has its own benefits. Digital wallets can in some circumstances be referred to as crypto wallets. Typical crypto wallets include COINBASE®, LEDGER®, METAMASK®, ELECTRUM®, MYCLEIUM®, and EXODUS®, among others and are essentially programs that hold one's crypto assets and provide the user with a password or key to access their currency. Digital wallets come in different forms, for example, LEDGER® is a hardware wallet, like a USB stick, while COINBASE® is a web/mobile app. Hardware wallets are considered less risky but have a certain loss of functionality since one can't access their digital currency unless they are in physical possession of their wallet. Additionally, hardware wallets risk loss or destruction and if they are lost, cryptocurrency may also be lost. By contrast, on-line wallets are easier to use and not susceptible to being physically lost, but since they reside on-line, they are potentially more susceptible to hacking, corruption and theft. Digital wallets provide the software “key” to unlocking one's digital assets that resides in the blockchain. If a user loses his private password/key, seed phrase, or crypto wallet, he may never be able to recover his assets.

As used herein “token” refers to an asset in a blockchain transaction, which identifies another asset that may be a real-world asset or a digital asset. The “token” can be a fungible token or a non-fungible token. Fungible tokens are tokens that can be exchanged for other tokens or the same type or value, while non-fungible tokens (NFTs) are indivisible and represent a unique item. Fungible tokens can be divided into smaller pieces and are therefore transferrable as a fraction. Cryptocurrency is a form of fungible token.

As used herein “Asset Transaction Rail” refers to the secure, scalable infrastructure needed to manage and transact tokenized assets. It generally includes a distributed network of nodes, a hybrid consensus mechanism, and a smart contract platform.

As used herein “Tokenization” refers to the process of converting an asset and rights, or claim to the asset, into a digital representation, or token, on a blockchain network. A tokenized asset being driven by cryptographic keys, as opposed to account management and asset management by a system operator, for example, a bank.

As used herein a “crypto asset” refers to a digital currency which is a medium of exchange or a protocol-driven exchange mechanism that can embody the same characteristics of a real-world currency, such as durability, limited supply, and recognition by a network, while being backed by a common belief system (like a fiat currency). A crypto asset or currency generally represents a byproduct of trust systems (consensus) as a vehicle to back the incentive economic model that rewards and fuels the trust system of a network, making it a trust currency of the network.

As used herein “global ledger” refers to a database that maintains information on the current status of any asset that it associated with the Ledger Integration Platform as described herein.

As used herein, “digital asset recordation notice” refers to information compiled and sent to a user of a traditional ledger in their enterprise appropriate format instructing them to record a digital asset in their ledger.

As used herein “periodic” is given its ordinary meaning and indicates that something is done at intervals. Intervals can mean continuously, or any articulable interval, for example, a minute, an hour or a day, a week, a month. Periodic as used herein can also refer to after a repeating event, for example, whenever a transaction occurs.

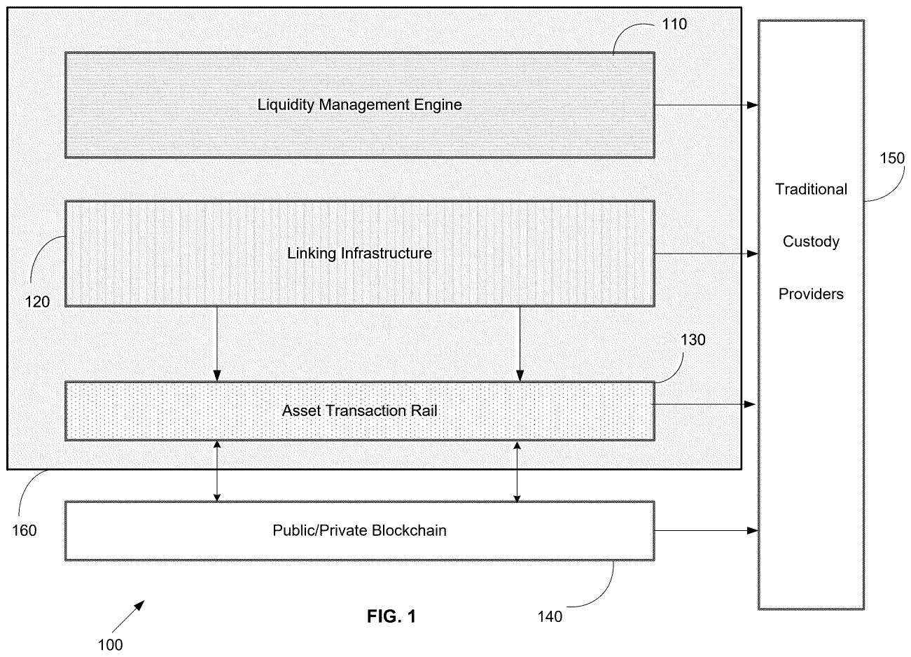

FIG. 1 illustrates a system architecture for the ledger integration platform 100 as described. As seen in FIG. 1, public and private blockchain networks 140 can be integrated with traditional custody partners 150 using a platform 160 including an Asset Transaction Rail 130, a Linking Infrastructure 120 and a Liquidity Management Engine 110.

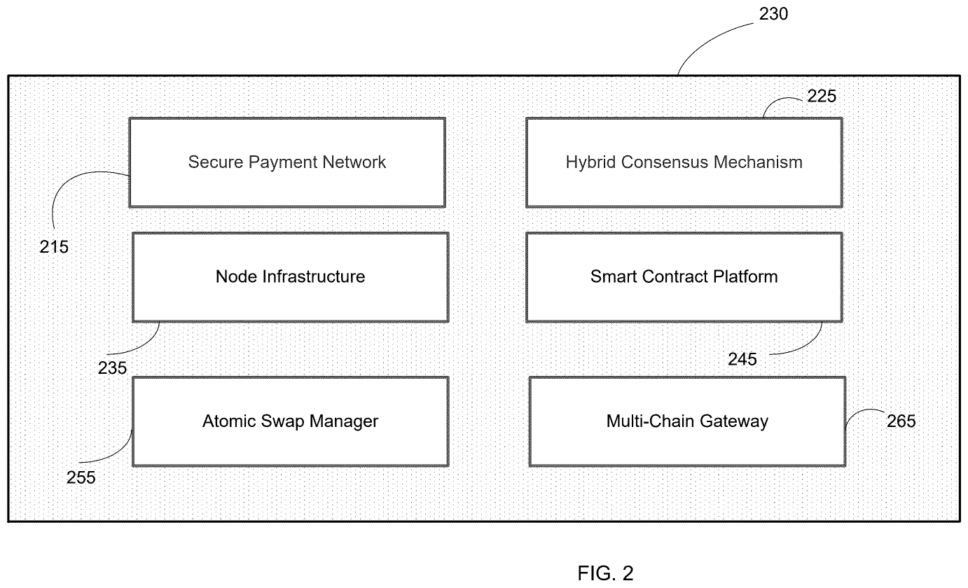

FIG. 2 illustrates one example of an Asset Transaction Rail 230. As seen in FIG. 2, the Asset Transaction Rail 230 includes a secure payment network 215, a node infrastructure 235, a hybrid consensus mechanism 225, a smart contract module 245 and an Atomic Swap module 255.

The secure payment network 215 manages tokenized assets, supports high transaction volumes, and ensures low-latency processing. This network is built on a distributed ledger technology that provides transparency and immutability, ensuring that all transactions are recorded and can be audited.

The node infrastructure 235 is a distributed network of nodes that validate transactions and maintain the ledger. This decentralized architecture enhances system reliability and security, reducing the risk of a single point of failure.

The hybrid consensus mechanism 225 combines Proof-of-Stake (PoS) and Practical Byzantine Fault Tolerance (PBFT). This approach allows for fast, secure transactions while minimizing energy consumption and ensuring the network's integrity.

The smart Contract platform 245 supports automated processes, reducing the need for intermediaries and enabling the creation of complex financial products. Smart contracts are self-executing contracts with the terms of the agreement directly written into code, ensuring transparency and reducing the risk of disputes.

The Atomic Swap Manager 255 facilitates seamless asset swaps across different digital assets. Atomic swaps allow users to exchange one cryptocurrency for another without the need for a trusted third party. This feature is crucial for institutions looking to diversify their digital asset portfolios or hedge against market volatility.

The Multi-chain Gateway 265 supports interoperability across various blockchain networks. It allows users to move assets between different blockchains, enabling greater flexibility and liquidity. This feature is particularly important for institutions that operate in multiple markets or need to manage assets across different jurisdictions.

In addition to the modules shown in FIG. 2, the Asset Transaction Rail may include one or more of a Blockchain Abstraction Layer and front-end channels. The Asset transaction Rails provides an end-to-end payment platform with built-in security protocols that adhere to cross-border banking standards, for example, ISO 20022.

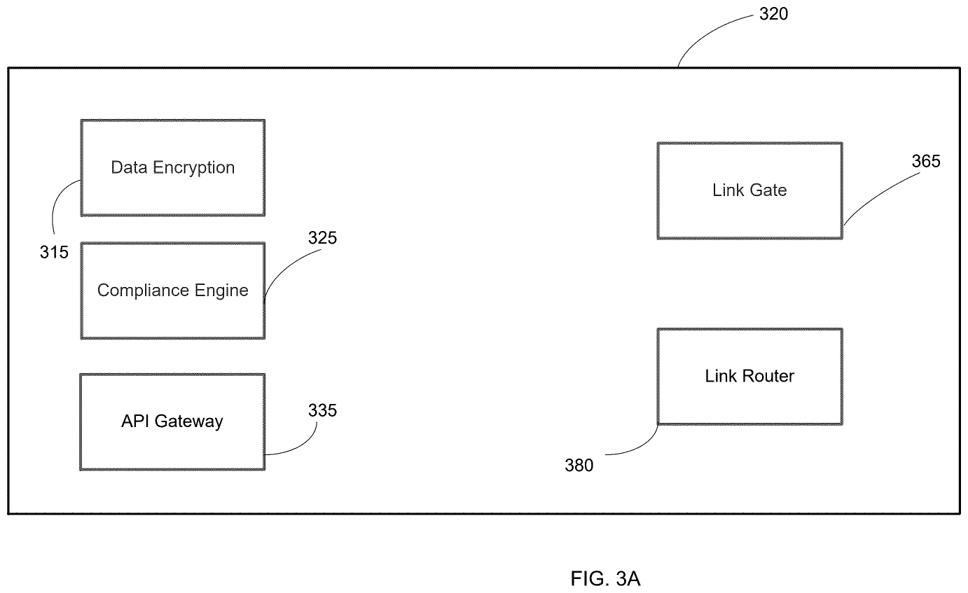

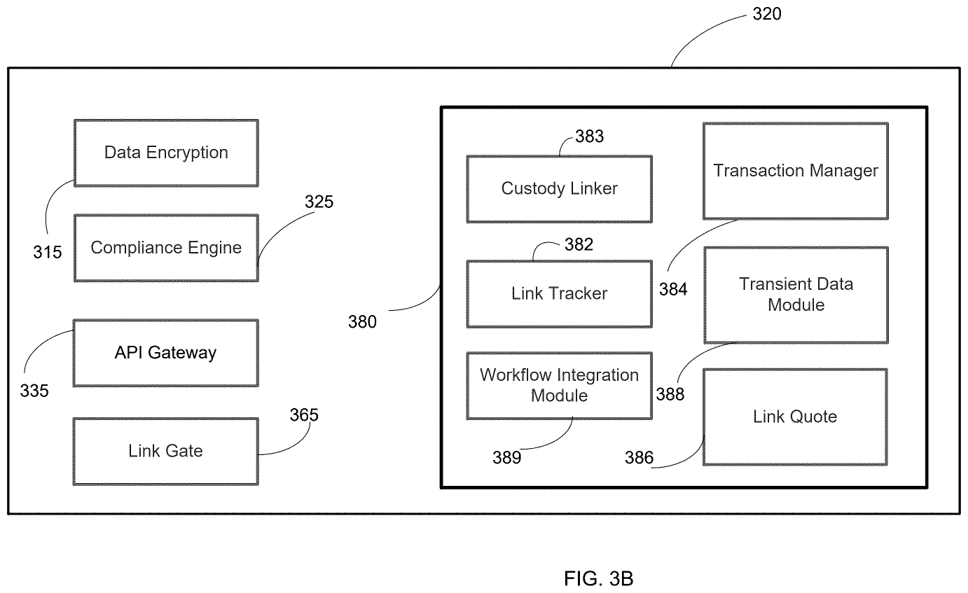

FIG. 3A illustrates one example of Linking Infrastructure 320. As seen in FIG. 3A, the Linking Infrastructure 320 includes a data encryption module 315, a compliance engine 335, an API gateway 335, a link gate 365 and a link router 380.

The data encryption module 315 uses advanced encryption techniques to protect data both at rest and in transit. All sensitive data is encrypted using industry-standard algorithms, ensuring that it cannot be accessed by unauthorized parties. The platform also supports secure key management, ensuring that encryption keys are stored and managed securely.

The compliance engine 325 continuously monitors transactions for compliance with regulatory requirements, including AML/KYC protocols. The engine uses machine learning algorithms to detect suspicious activity and alert users to potential regulatory violations.

The API gateway 335 provides a unified interface for accessing all services available to a user on the ledger integration platform 160. It supports standardized connectors that enable easy integration with legacy systems, reducing the need for custom development work. The API gateway also provides secure access to the ledger integration platform's platform, ensuring that only authorized users can interact with the system.

The link router 380 is a smart data hub comprising a centralized data repository that collects and analyzes transaction data in real time. It provides users with actionable insights into their liquidity positions, transaction history, and market trends. The link router 380 is integrated with the Liquidity Management Engine 110 to access AI-driven analytics tools, enabling institutions to make informed decisions based on real-time data.

The link gate 365 is a secure storage solution for tokenized assets. It supports multi-signature authentication and cold storage, providing a high level of security for digital assets. The gate 365 is also integrated with compliance engine 325, ensuring that all transactions meet regulatory requirements. The gate can further be configured to incorporate a number of design options. For example, the gate 365 can be configured for Role-Based Access Control (RBAC) to control who can configure thresholds and handle exceptions; with a flexible rule engine that allows for the configuration of a wide variety of transaction thresholds and exceptions, with threshold management to set transaction thresholds based on any number of criteria including transaction value, frequency, or other criteria as required by the business; with exception handling and real-time notifications to alert appropriate personnel when exceptions are triggered or thresholds are exceeded to support exception handling rules; with multi-signature approval allowing threshold to be set when a transaction requires multiple signatures for approvals. The gate 365 may further be configured as a unified view interface having automatic key management, a simplified user interface, straight through processing, single sign-on and audit capabilities among others features.

FIG. 3B illustrates one example of the Link Router 380 of FIG. 3A. As can be bees in FIG. 3B, the Link Router 380 can include a number of modules. The modules exemplified in FIG. 3B include link tracker module 382, a workflow integration module 389, a transaction manager 384, a transient data module 388, and an asset valuation module 386. While not shown, the Link Router 380 could include modules to carry out other asset tracking and validation.

The link tracker module 382 logs assets that are identified by link gate 365. The Transaction Manager 384 manages the Link Gate 365 to commit the asset to Custody provider (Digital Signature into KM (Key Management) systems) and ensure that the message is consumed by subscriber with assured delivery to downstream systems. This can also be achieved by common event infrastructure of Smart Message Hub. The system may record unique identifiers and time stamps for digital asset and compare these identifiers to verify that no duplicates exist.

The workflow integration module 389 sits between Transaction Manager 384 and the Smart Message Hub, not shown, to control the management of messages, the governance and control of the Work Flow integration module 389 is between the assets movement to Custody via Link Gate 365 and its corresponding message processing in the Smart Message Hub.

The Custody Linker 383 is a module that provides liveliness indicator to unprocessed messages and corresponding messages in Asset Log Module to ensure the assets are in custody and have a corresponding message in Smart Message Hub and Asset Log Module. The Custody Linker can also be tied to ensure the liveliness indicator of all custodied and accounted for assets to provide real time view of assets at hand and any asset that may encounter technical or cybersecurity risks. If discrepancies are discovered, the system can provide notifications, transfer the assets to a secure back-up, initiate recover protocols.

The transient data module 388 determines the current messaging standards per asset class e.g., ISO2022, MT101, MT103, FIX etc., and confirms that message and data formats are accurate. Transient Data Module 388 may connect to a Smart Message Hub, not shown, to process messages to right queues with appropriate QoS.

The Link Quote 386 is an asset valuation module that is integrated into market data providers for Crypto, and traditional market data providers and custom Tokenization provided value sets. Link Quote 386 determines the value of the asset and constructs the Messaging data for transaction processing using Transient Data Module 388.

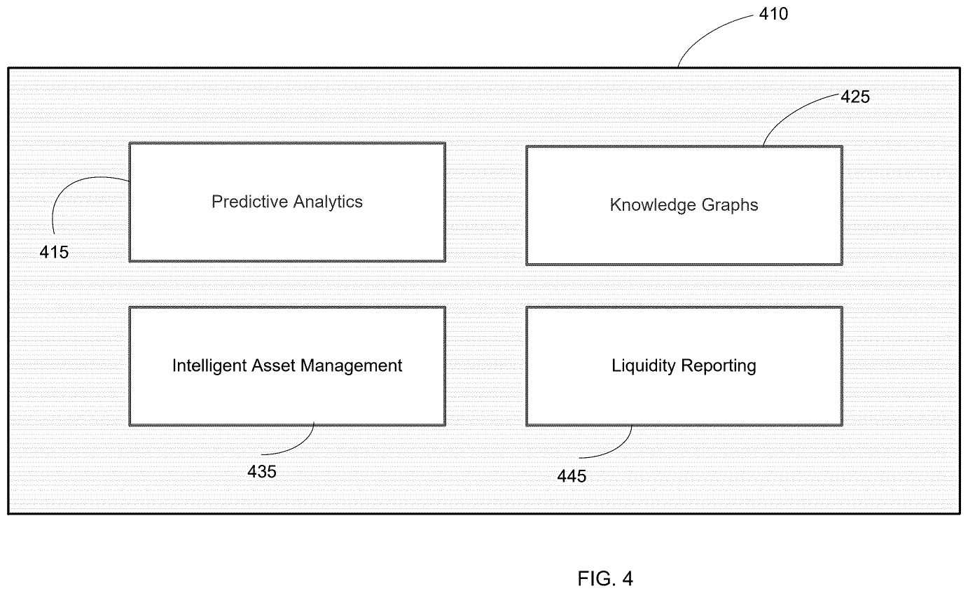

FIG. 4 illustrates one example of Liquidity Management Engine 410 of FIG. 3. As seen in FIG. 4, the Liquidity Management Engine 410 includes predictive analytics 415, An Intelligent Asset Management Module 435, a Knowledge Graphs module 425, and a Liquidity Reporting Tool 445.

The Intelligent Asset Management module 435 includes AI-powered real-time analytics and insights into asset performance. It uses machine learning algorithms to analyze market data, predict trends, and optimize asset management strategies. This feature helps institutions maximize returns on their digital assets while minimizing risk.

The ledger integration platform's liquidity management tools provide real-time insights into an institution's liquidity position. These tools help institutions optimize their liquidity by analyzing cash flows, forecasting future needs, and identifying opportunities to improve liquidity efficiency. The platform's AI-driven analytics provide actionable insights that help institutions make informed decisions and manage risk effectively.

The Liquidity Reporting module 445, provides information regarding liquidity of the traditional enterprise as it relates to transactions within a DTL. Traditional ledger-based enterprises typically have transaction times that are extended, and financial institutions work within these transactions times to be sure they maintain an appropriate level of liquidity. With the inclusion of DTL transactions in traditional ledgers, which transactions are immediate, the Liquidity Management Engine, uses a number of different platforms to assure appropriate levels of liquidity are preserved in the traditional institution when DTL transactions are involved.

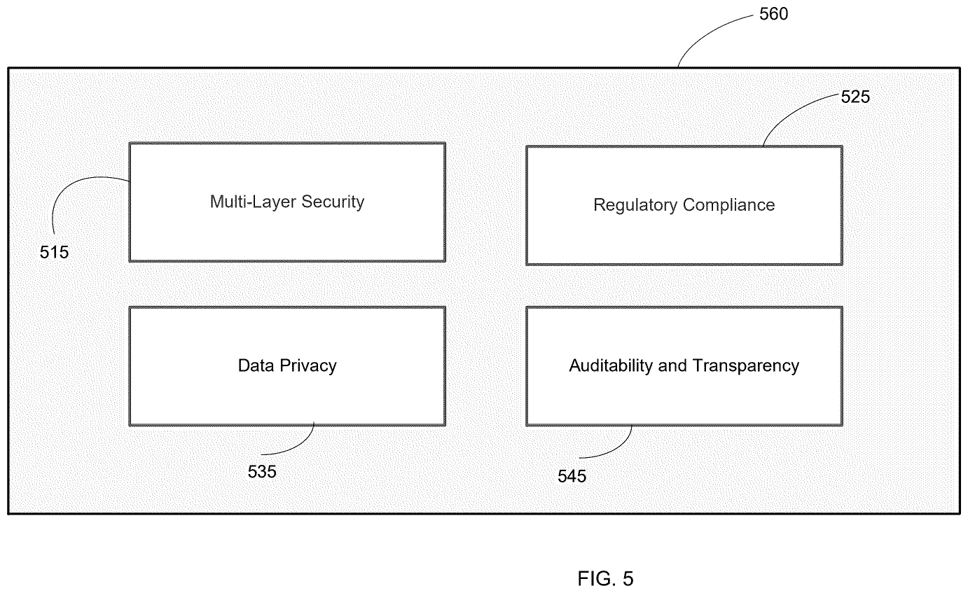

FIG. 5 illustrates one security and compliance framework to protect the platform 560 (corresponding to platform 160, FIG. 1). As seen in FIG. 5, the platform 560 can include modules for multilayer security 515, data privacy 535, auditability and transparency 545 ant regulatory compliance 525.

The multi-layer security 515 includes encryption, authentication, and network security protocols. This approach ensures that all data and transactions are protected against unauthorized access and cyber threats.

Data privacy 535 includes advanced encryption techniques to protect data both at rest and in transit. In addition, key management includes art recognized encryption and data protection algorithms to ensure that encryption keys are stored and managed securely.

The ledger integration platform 160 is designed to comply with a wide range of regulatory requirements, including ISO 20022 and AML/KYC protocols. The regulatory compliance module 525 provides compliance data for both traditional ledger systems and digital asset transaction systems and in combination with the platform's compliance engine 325 continuously monitors transactions for potential regulatory violations and alerts users to any issues.

The auditability and transparency module 545 ensures that all transactions are recorded in an auditable way. The ledger integration platform's 160 distributed ledger ensures that all transactions are recorded and can be audited by authorized parties. This feature is particularly important for institutions that need to demonstrate compliance with regulatory requirements.

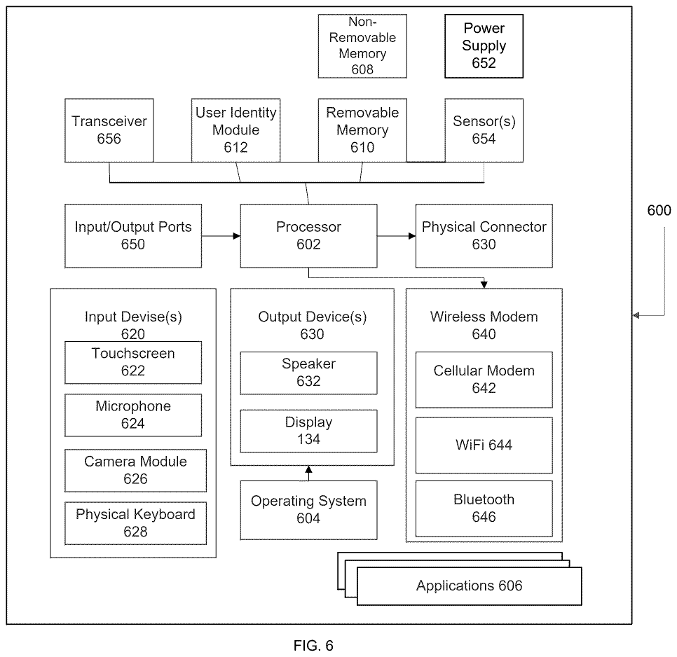

FIG. 6 is one general embodiment of a computer system 600 that may be used in the execution of the ledger integration platform as exemplified. As will be readily understood by the skilled artisan, the hardware that may be used in conjunction with the platform as describe may be any art recognized computer system that now exists or is after developed as long as it has sufficient capability to carry out the various processes described.

FIG. 6 is a simplified block diagram of an electronic device 600 capable of implementing the various embodiments of the present disclosure. It should be understood that the electronic device 600 as illustrated and hereinafter described is merely illustrative of one type of device and should not be taken to limit the scope of the embodiments. As such, it should be appreciated that at least some of the components described below in connection with that the electronic device 600 may be optional and thus, in an example embodiment may include more, less, or different components than those described in connection with the example embodiment of the FIG. 6. As such, among other examples, the electronic device 600 could be any of a mobile electronic device or may be embodied in any of the electronic devices, for example, cellular phones, tablet computers, laptops, mobile computers, personal digital assistants (PDAs), mobile televisions, mobile digital assistants, or any combination of the aforementioned other types of communication or multimedia devices.

The illustrated electronic device 600 includes a controller or a processor 602 (e.g., a signal processor, microprocessor, ASIC, or other control and processing logic circuitry) for performing such tasks as signal coding, data processing, image processing, input/output processing, power control, and/or other functions. An operating system 604 controls the allocation and usage of the components of the electronic device 600 and supports one or more application programs (e.g., the ledger integration platform) that implement one or more of the innovative features described herein. The applications 606 may include common mobile computing applications (e.g., telephone applications, email applications, calendars, contact managers, web browsers, messaging applications such as USSD messaging or SMS messaging or SIM Tool Kit (STK) application) or any other computing application.

The illustrated electronic device 100 includes one or more memory components, for example, a non-removable memory 108 and/or a removable memory 610. The non-removable memory 108 and/or the removable memory 610 may be collectively known as a “database” in an embodiment. The non-removable memory 608 can include RAM, ROM, flash memory, a hard disk, or other well-known memory storage technologies. The removable memory 610 can include flash memory, smart cards, or a Subscriber Identity Module (SIM). The one or more memory components can be used for storing data and/or code for running the operating system 104 and the applications. The electronic device 600 may further include a user identity module (UIM) 612. The UIM 612 may be a memory device having a processor built-in. The UIM 612 may include, for example, a subscriber identity module (SIM), a universal integrated circuit card (UICC), a universal subscriber identity module (USIM), a removable user identity module (R-UIM), or any other smart card. The UIM 612 typically stores information elements related to a mobile subscriber. The UIM 612 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution) or fifth generation wireless signals transmitted through large numbers of small cell stations at a spectrum between 30 and 300 gigahertz (GHz) at high speeds (5G).

The electronic device 600 can support one or more input devices 620 and one or more output devices 630. Examples of the input devices 620 may include but are not limited to, a touch screen/a display screen 622 (e.g., capable of capturing finger tap inputs, finger gesture inputs, multi-finger tap inputs, multi-finger gesture inputs, or keystroke inputs from a virtual keyboard or keypad), a microphone 624 (e.g., capable of capturing voice input), a camera module 626 (e.g., capable of capturing still picture images and/or video images), a physical keyboard 628 or any other after developed input device.

Examples of the output devices 630 may include but are not limited to a speaker 632 and a display 634. Other possible output devices can include piezoelectric, haptic output devices, or any other after-developed output device. Some devices can serve more than one input/output function. For example, the touchscreen 622 and the display 634 can be combined into a single input/output device.

A modem 640 can be coupled to one or more antennas (not shown in FIG. 6) and can support two-way communications between the processor 602 and external devices, as is well understood in the art. The modem 640 is shown generically and can include, for example, a cellular modem 642 for communicating at long range with the mobile communication network, a Wi-Fi compatible modem 644 for communicating at short range with an external Bluetooth-equipped device or a local wireless data network or router, and/or a Bluetooth-compatible modem 646. The wireless modem 640 is typically configured for communication with one or more cellular networks, such as a GSM network for data and voice communications within a single cellular network, between cellular networks, or between the electronic device 600 and a public switched telephone network (PSTN).

The electronic device 600 can further include one or more input/output ports 150, a power supply 652, one or more sensors 654 for example, an accelerometer, a gyroscope, a compass, or an infrared proximity sensor for detecting the orientation or motion of the electronic device 600, a transceiver 656 (for wirelessly transmitting analog or digital signals) and/or a physical connector 160, which can be a USB port, IEEE 1294 (FireWire) port, and/or RS-232 port. The illustrated components are not required or all-inclusive, as any of the components shown can be deleted, and other components can be added.

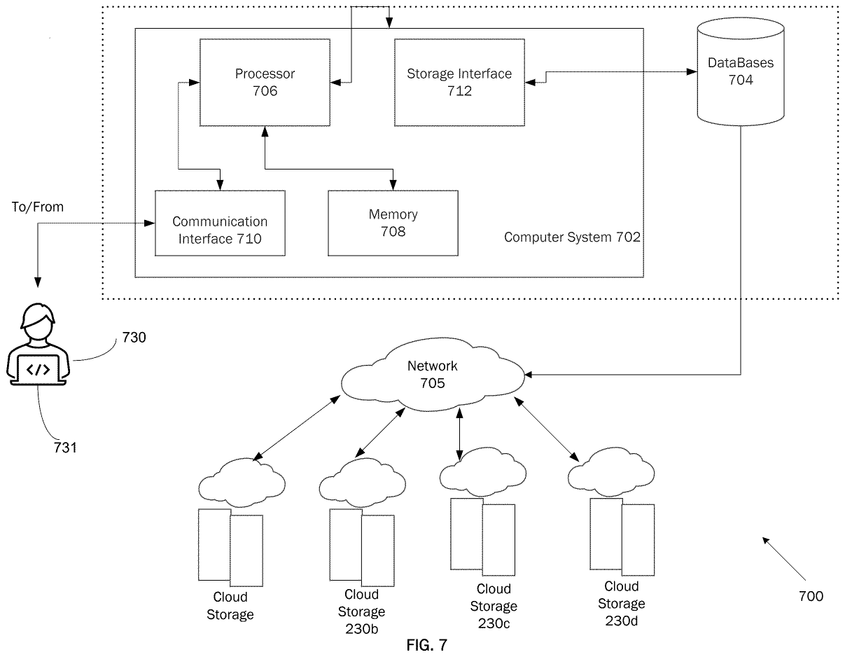

FIG. 7 illustrates a typical computing environment 700 for use with the computer system of FIG. 1 in which the methods as described herein can operate. An enterprise or institution 730 interacts with a network 705 via a computer or smart device 731. Examples of the device 731 may take the form of any portable electronic device (e.g., laptops, smartphones and tablets, radio receivers, wireless communicators) having cellular and/or WIFI communication capabilities. For instance, the device 731 may be equipped with subscriber identity module (SIM) or Removable User Identity Module (R-UIM) to enable cellular communication. The network may include a computer system 702 and databases 704 that are commonly located or that are distributed and decentralized. In at least one example embodiment, the computing system 702 including at least a processor 706, memory 708, a storage interface 712 and a communication interface 710 can be a single computing system in which a local drive or a shared drive may be stored. The network 705 which typically includes cloud storage 730, may be centralized or decentralized and may comprise a plurality of sub-networks that may offer a direct communication between the entities or may offer indirect communication between the entities. Examples of the network 705 include, but are not limited to, the Internet, local area network (LAN), wide area network (WAN), wireless, wired, and the like.

FIG. 7 depicts a cloud computing environment in accordance with the present disclosure. Software as a Service (SaaS) is a system whereby the enterprise uses the provider's applications running on a cloud infrastructure. The applications are accessible from various client devices through a thin client interface such as a web browser (e.g., web-based e-mail). The enterprise does not manage or control the underlying cloud infrastructure including the network(s) 705, servers, operating systems, storage, or even individual application capabilities, with the possible exception of limited user-specific application configuration settings. It is understood in advance that although this disclosure includes a description on cloud computing and SaaS implementation, implementation of the teachings recited herein are not limited to a cloud computing environment. Rather, embodiments of the present invention are capable of being implemented in conjunction with any other type of computing environment now known or later developed.

Financial Institutions may use the ledger integration platform as described to transact business in the space between traditional ledger assets and digital assets. For example, financial institutions can use the ledger integration platform as described to effectuate instant Settlements. Traditional financial systems often involve lengthy settlement processes, especially for cross-border transactions. The disclosed ledger integration platform enables instant settlements, reducing the time and cost associated with these transactions. By leveraging blockchain technology, the ledger integration platform ensures that transactions are processed in real-time, providing greater efficiency and transparency.

Financial institutions may also use the ledger integration platform as described to carryout cross-border payments. Cross-border payments are often complex and costly due to differences in regulations, currencies, and payment systems. The ledger integration platform simplifies cross-border payments by providing a unified platform for processing transactions across different jurisdictions. The platform's Multi-chain Gateway supports interoperability between different blockchain networks, enabling seamless cross-border transactions.

Financial institutions may also use the ledger integration platform to manage tokenized assets, including securities, commodities, and real estate. The platform's secure storage solutions and compliance tools ensure that tokenized assets are managed securely and meet regulatory requirements.

Corporate treasuries may use the ledger integration platform as described to transact business in the space between traditional ledger assets and digital assets. For example, corporate treasuries can use the ledger integration platform as described to streamline treasury operations. The ledger integration platform provides tools for automating and streamlining treasury operations, including cash management, payment processing, and liquidity forecasting. The platform's AI-driven analytics provide real-time insights into cash flows, helping treasurers optimize their liquidity positions and reduce operational costs.

Corporate treasuries can also use the ledger integration platform as described to for cash management and liquidity forecasting. The ledger integration platform's liquidity management tools help corporate treasuries optimize their liquidity by analyzing cash flows, forecasting future needs, and identifying opportunities to improve liquidity efficiency. The platform's AI-driven analytics provide actionable insights that help treasurers make informed decisions and manage risk effectively.

Corporate treasuries may use the ledger integration platform as described to manage digital assets. Specifically, corporate treasuries can use The ledger integration platform to manage digital assets as part of their overall portfolio strategy. The platform's secure storage solutions and compliance tools ensure that digital assets are managed securely and meet regulatory requirements.

Private markets may use the ledger integration platform as described to transact business in the space between traditional ledger assets and digital assets. For example, private markets can use the ledger integration platform as described to tokenize illiquid assets. The ledger integration platform supports the tokenization of a wide range of illiquid assets, including real estate, private equity, and collectibles. Tokenization enables greater liquidity and market access for these assets, providing new opportunities for investors and asset managers.

Asset Liquidity and Market Access: By tokenizing illiquid assets, the ledger integration platform enables private markets to access new sources of liquidity and market participants. The platform's Multi-chain Gateway supports interoperability between different blockchain networks, enabling seamless asset transfers and market access.

Management of Tokenized Portfolios: The ledger integration platform provides tools for managing tokenized portfolios, including asset tracking, performance analytics, and compliance monitoring. The platform's AI-driven analytics provide real-time insights into portfolio performance, helping asset managers optimize their strategies and maximize returns The ledger integration platform as described can be used to connect traditional Finance with decentralized finance (DeFi). For example, the ledger integration platform acts as a bridge between traditional finance and DeFi, enabling financial institutions to access the benefits of decentralized finance while maintaining compliance with regulatory requirements. The platform's Multi-chain Gateway supports interoperability between different blockchain networks, enabling seamless integration with DeFi applications.

The ledger integration platform can be used for a wide range of DeFi use cases, including lending, borrowing, and trading of digital assets. The platform's secure storage solutions and compliance tools ensure that DeFi transactions are managed securely and meet regulatory requirements. Furthermore, one of the biggest challenges for DeFi is regulatory compliance. The ledger integration platform as described provides the tools and infrastructure needed to ensure that DeFi transactions meet regulatory requirements. The platform's compliance engine continuously monitors transactions for potential regulatory violations and alerts users to any issues.

One should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which comprise one or more executable instructions for implementing specific logical functions or steps in the process, and alternate implementations are included in which functions may not be included or executed at all, can be executed out of order from that shown or discussed, including substantially concurrently or in reverse order, depending on the functionality involved, as would be understood by those reasonably skilled in the art of the present disclosure. Many variations and modifications can be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

We claim:

1. A method for incorporating digital assets into a traditional ledger system comprising:
receiving from a traditional ledger user via a processor, a request for purchase, sale or custody of a digital asset within a distributed transaction ledger (DTL);
obtaining, via the processor, information on the digital asset from the DTL;
recording, via the processor, custody of the digital asset including any required key(s);
determining, via the processor, the value of the digital asset;
determining, via the processor, the asset class of the digital asset and the proper messaging standard associated with the user's traditional ledger;
applying, via the processor, the proper messaging standard and asset class to generate a digital asset recordation notice; and
sending to the user of the traditional ledger, the digital asset recordation notice instructing them to record the digital asset in their traditional ledger.

2. The method of claim 1, further comprising:
prior to sending the record to the user, determining, via a compliance engine, whether the digital asset complies with required regulatory requirements.

3. The method of claim 1, wherein the request is for the purchase of a new digital asset.

4. The method of claim 3, further comprising:
determining, via the processor, if the traditional ledger user has sufficient liquidity to purchase the requested digital asset; and
upon receipt of liquidity, requesting, via the processor, purchase of the digital asset within the DTL.

5. The method of claim 4, further comprising:
if liquidity is not established, generating, via the processor, a notification to the traditional ledger user that the transaction will substantially deplete their liquidity or that they have insufficient liquidity to carry out the transaction.

6. The method of claim 5, further comprising:
receiving, via the processor, from the traditional ledger user, a request to override the liquidity notice and purchase the digital asset;
recording, via the processor, the digital asset in a general ledger.

7. The method of claim 1, further comprising:
receiving, via the processor, from the traditional ledger user, a request to delay the purchase of the digital asset until liquidity is established.

8. The method of claim 1, wherein the transaction is the sale or custody of a digital asset and the method further comprises:
recording, via the processor, the digital asset in a general ledger.

9. The method of claim 8, further comprising
generating, via the processor, a periodic check on the status of the digital asset in the general ledger by comparing the general ledger with the DTL and the user's traditional ledger.

10. The method of claim 1, further comprising:
generating, via the processor, an enterprise wallet for receiving and holding digital asset from the DTL;
digitally signing, via the processor, a smart contract regarding the one or more digital assets in the enterprise wallet.

11. A system for incorporating digital assets into a traditional ledger system comprising:
a processor; and
a memory for storing computer executable instructions, the processor configured to execute the instructions to:
receive, from a traditional ledger user via a processor, a request for purchase, sale or custody of a digital asset within a distributed transaction ledger (DTL);
obtain, via the processor, information on the digital asset from the DTL;
record, via the processor, custody of the digital asset including any required key(s);
determine, via the processor, the value of the digital asset;
determine, via the processor, the asset class of the digital asset and the proper messaging standard associated with the user's traditional ledger;
apply, via the processor, the proper messaging standard and asset class to generate a digital asset recordation notice; and
send to the user of the traditional ledger, the digital asset recordation notice instructing them to record the digital asset in their traditional ledger.

12. The system of claim 11, further comprising further configuring the processor to execute instructions to:
prior to sending the record to the user, determine, via a compliance engine, whether the digital asset complies with required regulatory requirements.

13. The system of claim 11, wherein the request is for the purchase of a new digital asset.

14. The system of claim 13, further comprising further configuring the processor to execute instructions to:
determine, via the processor, if the traditional ledger user has sufficient liquidity to purchase the requested digital asset; and
upon receipt of liquidity, request, via the processor, purchase of the digital asset within the DTL.

15. The system of claim 14, further comprising further configuring the processor to execute instructions to:
if liquidity is not established, generate, via the processor, a notification to the traditional ledger user that the transaction will substantially deplete their liquidity or that they have insufficient liquidity to carry out the transaction.

16. The system of claim 15, further comprising further configuring the processor to execute instructions to:
receive, via the processor, from the traditional ledger user, a request to override the liquidity notice and purchase the digital asset; and
record, via the processor, the digital asset in a general ledger.

17. The system of claim 11, further comprising further configuring the processor to execute instructions to:
receive, via the processor, from the traditional ledger user, a request to delay the purchase until liquidity is established.

18. The system of claim 11, wherein the transaction is the sale or custody of a digital asset and further comprises further configuring the processor to execute instructions to:
record, via the processor, the digital asset in a general ledger.

19. The system of claim 18, further comprising further configuring the processor to execute instructions to:
generate, via the processor, a periodic check on the status of the digital asset in the general ledger by comparing the general ledger with the DTL and the user's traditional ledger.

20. The system of claim 11, further comprising further configuring the processor to execute instructions to:
generate, via the processor, an enterprise wallet for receiving and holding digital asset from the DTL;
digitally sign, via the processor, a smart contract regarding the one or more digital assets in the enterprise wallet.
